(19) United States
(12) Patent Application Publication
(10) Pub. No.: US 2010/0192844 A1
(43) Pub. Date: Aug. 5, 2010

(54) Apparatus and method for treating substrate

(75) Inventors: Dong Ho Kim, Cheonan-si (KR); Jinyoung Choi, Cheonan-si (KR); Jaeseung Go, Suwon-si (KR); Hyoung Rae Noh, Cheonan-si (KR)

Correspondence Address: HARNESS, DICKEY & PIERCE, P.L.C., P.O. BOX 8910, RESTON, VA, 20195, US

(73) Assignee: SEMES CO., LTD.

(21) Appl. No.: 12/656,449

(22) Filed: Jan. 29, 2010

(30) Foreign Application Priority Data
Jan. 30, 2009 (KR) 10-2009-0007629
Mar. 31, 2009 (KR) 10-2009-0027375

(51) Int. Cl. B05C 9/12; B05C 13/00; B05C 9/10; B05C 9/14

(52) U.S. Cl. 118/69; 118/500; 118/72; 118/600; 118/58

(57) ABSTRACT

An apparatus and method for treating a substrate are provided. The apparatus includes a load port, an index module, a first buffer module, a coating/developing module, a second buffer module, a pre/post-exposure treatment module, and an interface module, which are sequentially arranged in a direction. The coating/developing module includes a coating module and a developing module, which are arranged in different layers. The pre/post-exposure treatment module includes a pre-treatment module and a post-treatment module, which are disposed at different layers. The pre-treatment module coats a protective layer on the wafer before an exposure process. The post-treatment module performs a wafer cleaning process and a post-exposure bake process after the exposure process. A robot for transferring the wafer is disposed in each of the pre-treatment and post-treatment modules.

### CROSS-REFERENCE TO RELATED APPLICATIONS

This U.S. non-provisional patent application claims priority under 35 U.S.C. §119 of Korean Patent Application Nos. 10-2009-0007629, filed on Jan. 30, 2009, and 10-2009-0027375, filed on Mar. 31, 2009, the entire contents of which are hereby incorporated by reference.

### BACKGROUND OF THE INVENTION

The present invention disclosed herein relates to an apparatus and method for treating a substrate, and more particularly, to an apparatus and method used for performing a photolithography process for a wafer.

A variety of processes such as a cleaning process, a depositing process, a photolithography process, an etching process, an ion implanting process, etc are performed to manufacture semiconductor devices. The photography process for forming a pattern plays an important role in high integration of the semiconductor devices.

Generally, a system for performing the photolithography process includes a coating unit for coating resist on a wafer, a developing unit for performing a developing process for the wafer that has gone through an exposure process, and a treating module having an interface for inline-connection with an exposure apparatus. In recent years, in addition to the above-described processes, many other processes are required before and after the exposure process. According to a typical apparatus, the chambers performing the respective processes and return robots are inefficiently arranged and thus a schedule of the return robots cannot be efficiently provided.

### SUMMARY OF THE INVENTION

The present invention provides an apparatus and method for treating a substrate, which can improve efficiency of a photography process.

The present invention also provides an apparatus and method for treating a substrate, which can prevent process congestion that may be caused by increase of treatment amount of transferring robots.

The present invention also provides a substrate treatment apparatus having a layout that can efficiently arrange chambers performing processes.

Objects of the present invention are not limited to those mentioned above, and other objects of the present invention will be apparently understood by those skilled in the art through the following description.

Embodiments of the present invention provide apparatuses for treating a substrate, including a load port in which a container receiving the substrates is disposed; a first buffer module having a buffer for temporarily storing the substrates; an index module transferring the substrate between the load port and the first buffer module; a coating/developing module for performing a photoresist coating process and a developing process for the substrate; a second buffer module having a buffer for temporarily storing the substrates; a pre/post-exposure treatment module performing processes for the substrate between the photoresist coating process and an exposure process and between the exposure process and the developing process; and an interface module connected to an exposure module. The load port, index module, first buffer module, coating/developing module, second buffer module, pre/post-exposure treatment module, interface module are arranged in a line extending in a first direction. The pre/post-exposure treatment module may include a protective layer coating chamber coating a protective layer on the substrate. The pre/post-exposure treatment module may further include a cleaning chamber cleaning the substrate.

In some embodiments, the pre/post-exposure treatment module may include a pre-treatment module and a post-treatment module that are disposed at different layers. The protective layer coating chamber may be disposed in the pre-treatment module and the cleaning chamber may be disposed in the post-treatment module. In addition, the pre-treatment module may further include a bake chamber performing a bake process for the substrate and a pre-treatment robot transferring the substrate between the bake chamber and the protective layer coating chamber. The post-treatment module may further include a post-exposure bake chamber performing a bake process for the substrate after the exposure process and a post-treatment robot transferring the substrate between the cleaning chamber and the post-exposure bake chamber.

In other embodiments, the second buffer module may further include an edge exposure chamber exposing an edge of the substrate and a second buffer robot transferring the substrate to the edge exposure chamber. The second buffer module may further include a cooling chamber cooling the substrate.

In still other embodiments, the coating/developing module may include a coating module and a developing module that are disposed at different layers. The coating module may include a coating chamber coating the photoresist on the substrate, a bake chamber heat-treating the substrate, and a coating robot transferring the substrate between the bake chamber of the coating module and the coating chamber. The developing module may include a developing chamber performing the developing process for the substrate, a bake chamber heat-treating the substrate, and a developing robot transferring the substrate between the bake chamber of the developing module and the developing chamber.

In even other embodiments, the coating module may be located at a same height as the pro-treatment module, and the developing module may be located at a same height as the post-treatment module. The second buffer module may include a cooling chamber performing a cooling process for the substrate. The buffer of the second buffer module may be located at a height corresponding to the coating module. The cooling chamber may be located at a height corresponding to the developing module.

In yet other embodiments, the interface module may include a first buffer disposed at a height corresponding to the pre-treatment module and temporarily storing the substrate; a second buffer disposed at a height corresponding to the post-treatment module and temporarily storing the substrate; and an interface robot transferring the substrate between the first buffer and the exposure unit and between the second buffer and the exposure unit.

In further embodiments, the protective layer coating chamber, a return chamber provided with the pre-treatment robot, and the bake chamber of the pre-treatment module may be sequentially arranged in a second direction perpendicular to the first direction when viewed from above. The cleaning chamber, a return chamber provided with the post-treatment robot, and the post-exposure bake chamber may be sequentially arranged in the second direction when viewed from above. Each of the return chamber provided with the pre-treatment robot and the return chamber provided with the post-treatment robot may be arranged side by side with the buffer of the second buffer module in the first direction. Each of the return chamber provided with the coating robot and the return chamber provided with the developing robot is arranged side by side with the buffer of the second module in the first direction.

In still further embodiments, the second buffer module may further include an edge exposure chamber exposing an edge of the substrate and a second buffer robot transferring the substrate to the edge exposure chamber. The buffer of the second buffer module, the second buffer robot, and the edge exposure chamber may be sequentially arranged in a second direction perpendicular to the first direction when viewed from above.

In other embodiments of the present invention, methods for treating the substrate include coating a photoresist on the substrate; coating a protective layer on the substrate on which the photoresist is coated; performing a liquid immersion lithography process for the substrate on which the protective layer is coated; cleaning the substrate that is treated by the liquid immersion lithography process; and performing a developing process for the substrate.

In some embodiments, the methods may further include performing a post-exposure bake process for the substrate after the cleaning of the substrate and before the performing of the developing process.

In other embodiments, the cleaning of the substrate may be performed by supplying cleaning liquid and the cleaning liquid remaining on the substrate may be removed by heating the substrate without supplying fluid.

In still other embodiments, the cleaning of the substrate may be performed by cleaning liquid and the cleaning liquid remaining on the substrate may be removed by a post-exposure bake process that is performed immediately after the cleaning of the substrate.

In still yet other embodiments, the protective layer may be removed in or after the developing process.

In still further embodiments, a part of the protective layer may be removed in the developing process and the rest may be removed in an ashing process.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIGS. 1 to 4 are schematic views of a substrate treatment apparatus according to an embodiment of the present invention,

FIGS. 5a and 5b are flowcharts illustrating sequential processes performed in the substrate treatment apparatus of FIG. 1, and

FIGS. 6a to 6g are schematic views illustrating sequential processes for forming a pattern on a wafer.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

The apparatus of the embodiment is used to perform a photolithography process for a substrate such as a semiconductor wafer or a flat display panel. Especially, the apparatus of the embodiment is used to perform a pre/post-exposure treatment process that is required before and after a coating process, developing process, and liquid immersion lithography processes. In the following description, a case where a wafer is used as the substrate will be described as an embodiment.

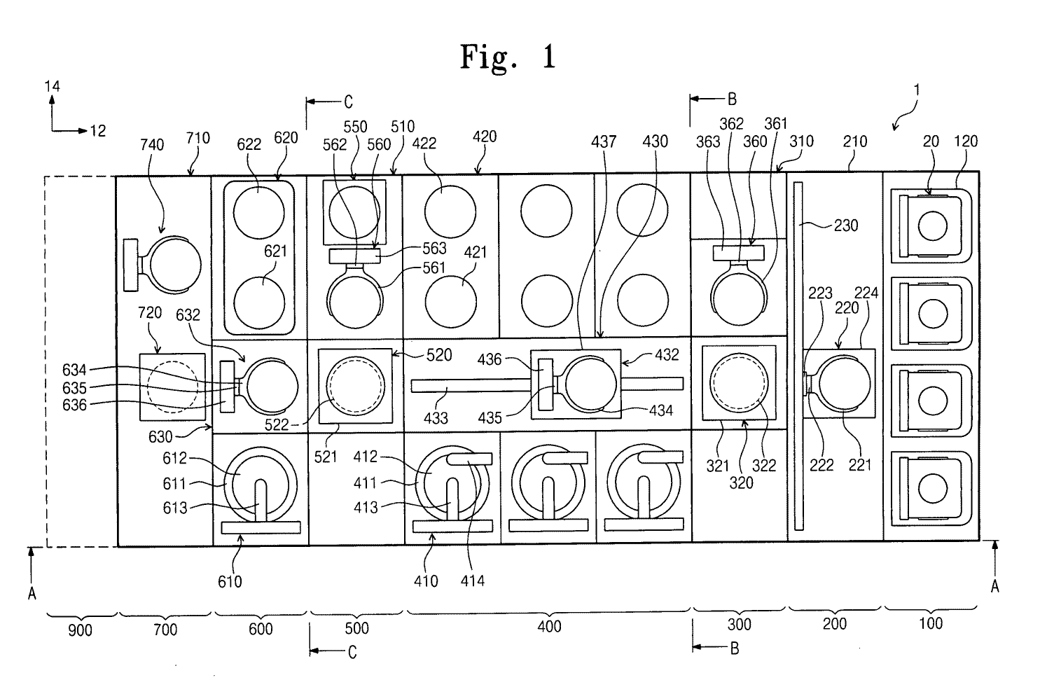

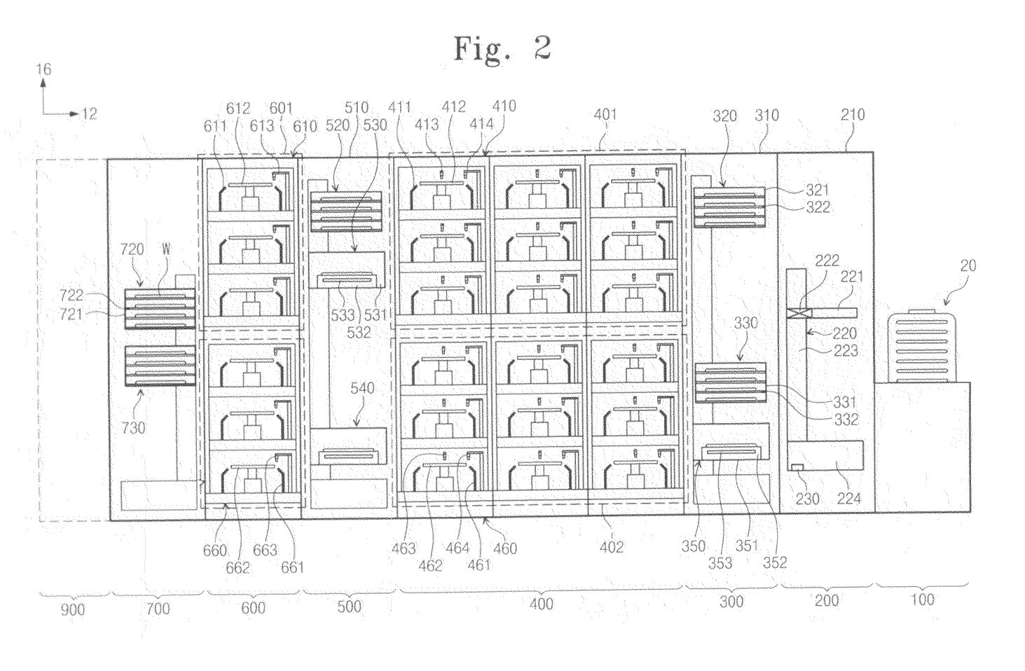

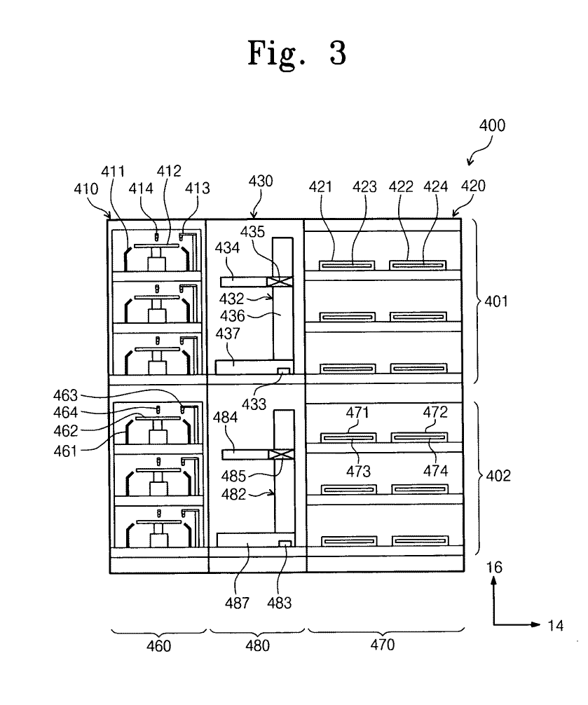

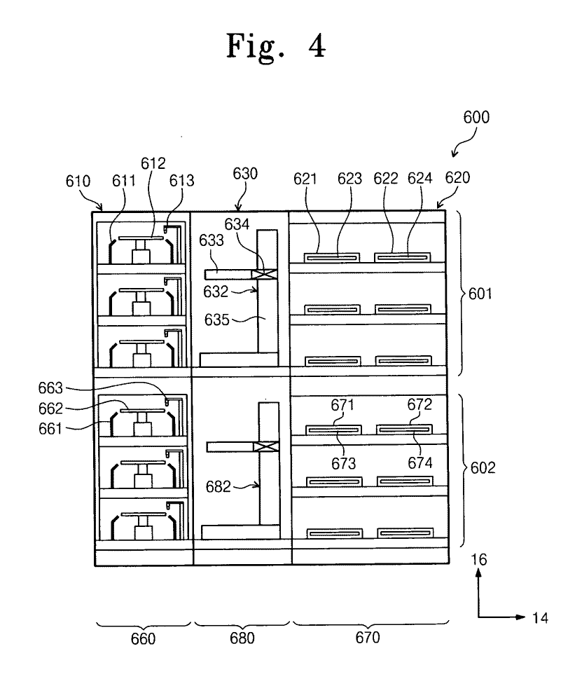

FIGS. 1 to 4 are schematic views of a substrate treatment apparatus 1 according to an exemplary embodiment of the present invention. That is, FIG. 1 is a top-plane view of the substrate treatment apparatus 1, FIG. 2 is a view taken along line A-A of FIG. 1, FIG. 3 is a view taken along line B-B of FIG. 1, and FIG. 4 is a view taken along line C-C of FIG. 1. A substrate treatment apparatus 1 includes a load port 100, an index module 200, a first buffer module 300, a coating/developing module 400, a second buffer module 500, a pre/post-exposure treatment module 600, and an interface module 700. The load port 100, index module 200, first buffer module 300, coating/developing module 400, second buffer module 500, pre/post-exposure treatment module 600, and interface module 700 are sequentially arranged in a line extending in a direction (hereinafter, referred to as “first direction 12”). In addition, the direction that is perpendicular to the first direction when viewed from above will be referred to as “second direction 14,” and the direction that is vertical to the first and second directions 12 and 14 will be referred to as “third direction 16.”

The wafers W are transferred in a state where they are received in a container 20. At this point, the container 20 is sealed from an external side. For example, a front open unified pod (FOUP) having a front door may be used as the container 20. The following will describe the constitutional elements with reference to FIGS. 1 to 4.

(Load Port)

The load port 100 includes a plurality of load tables 120 on which the container 20 receiving the wafers W is disposed. The load tables 120 are arranged in a line extending in the second direction 14. In FIG. 1, four load tables 120 are provided.

(Index Module)

The index module 3200 transfers the wafer W between the container 20 on the load table 120 of the load port 100 and the first buffer module 300. The index module 200 includes a frame 210, an index robot 220, and a guide rail 230. The frame 210 is generally formed in an empty rectangular parallelepiped shape. The frame 210 is disposed between the load port 100 and the first buffer module 300. The frame 210 of the index module 200 may have the lower height than a frame 310 of the first buffer module 300, which will be described later. The index robot 220 and the guide rail 230 are disposed in the frame 210. The index robot 220 has a 4-shaft driving structure such that a hand 221 directly handling the wafer W can rotate and move in the first, second, and third directions 12, 14, and 16. The index robot 220 includes an arm 222, a support 223, and a base 224 in addition to the hand 221. The hand 221 is fixedly installed on the arm 222. The arm 222 is provided to be expandable, contractible, and rotatable. The support 223 is disposed such that a length direction thereof extends in the third direction 16. The arm 222 is coupled to the support 223 to be movable along the support 223. The support 223 is fixedly coupled to the base 224. The guide rail 230 is provided such that a length direction thereof extends in the second direction 14. The base 224 is coupled to the guide rail 230 to be linearly movable along the guide rail 3230. Although not shown in the drawings, the frame 210 is provided with a door opener for opening and closing the door of the container 20.

(First Buffer Module)

The first buffer module 300 includes a frame 310, a first buffer 320, a second buffer 330, a cooling chamber 350, and a first buffer robot 360. The frame 310 is formed in an empty rectangular parallelepiped shape. The frame 310 is disposed between the index module 200 and the coating/developing module 400. The first buffer 320, second buffer 330, cooling chamber 350, first buffer robot 360 are disposed in the frame 310. The cooling chamber 350, second buffer 330, and first buffer 320 are sequentially arranged upward in the third direction 16. The first buffer 320 is located at a height corresponding to a coating module 401 of the coating/developing module 400, which will be described later. The cooling chamber 350 and the second buffer 330 are located at a height corresponding to a developing module 402 of the coating/developing module 400, which will be described later. The first buffer robot 360 is located to be spaced apart from the second buffer 330, cooling chamber 350, and first buffer 320 in the second direction 14 by a predetermined distance.

Each of the first and second buffers 320 and 330 temporarily stores a plurality of the wafers W. The second buffer 330 includes a housing 331 and a plurality of supports 332. The supports 332 are disposed in the housing 331 and spaced apart from each other in the third direction 16. One wafer W is disposed on each of the supports 332. The housing 331 is provided with openings (not shown) corresponding to the index robot 220, first buffer robot 360, and developing robot 482 (which will be described later) such that the index robot 220, first buffer robot 360, and developing robot 482 of the developing module 402 can carry or take the wafer W to or from the support 332. The first buffer 320 has a similar structure to the second buffer 330. However, the housing 321 of the first buffer 320 is provided with openings corresponding to the first buffer robot 360 and a coating robot 432 on the first module 401, which will be described later. The number of the supports 322 of the first buffer 320 may be same as or different from the number of the supports 332 of the second buffer 330. For instant, the number of the supports 332 of the second buffer 330 may be greater than the number of the supports 322 of the first buffer 320.

The first buffer robot 360 transfers the wafer W between the first and second buffers 320 and 330. The first buffer robot 360 includes a hand 361, an arm 362, and a support 363. The hand 361 is fixedly installed on the arm 362. The arm 362 is configured to be capable of expanding and contracting so that the hand 361 can move in the second direction 14. The arm 362 is coupled to the support 363 to be linearly movable along the support 363 in the third direction 16. The support 363 has a length extending from a location corresponding to the second buffer 330 to a location corresponding to the first buffer 320. The support 363 may further extend over the location corresponding to the second buffer 330 or the location corresponding to the first buffer 320. The buffer robot 360 may be configured to have a 2-shaft driving structure such that the hand 361 moves only in the second and third directions 14 and 16.

The cooling chamber 350 cools the wafer W. The cooling chamber 350 has a housing 351 and a cooling plate 352. The cooling plate 352 has a top surface on which the wafer W is disposed and a cooling element 353 cooling the wafer W. The cooling element 353 may be formed of a variety of elements such as cooling water, a thermoelectric module, and the like. In addition, the cooling chamber 350 may be provided with a lift pin assembly (not shown) locating the wafer W on the cooling plate 352. The housing 351 is provided with openings (not shown) corresponding to the index robot 220 and the developing robot 482 so that the index robot 220 and the developing robot 482 of the developing module 402 can carry or take the wafer W onto or from the cooling plate 352. In addition, the cooling chamber 350 may be provided with doors (not shown) for opening and closing the openings.

(Coating/Developing Module)

The coating/developing module 400 performs a coating process for coating photoresist on the wafer W before the exposure process and a developing process for developing the wafer W after the exposure process. The coating/developing module 400 is generally formed in a rectangular parallelepiped shape. The coating/developing 400 includes a coating module 401 and a developing module 402. The coating and developing modules 401 and 402 are arranged at different layers. For example, the coating module 401 is located above the developing module 402.

The coating module 401 performs a process for coating photoresist on the wafer W and processes for heating and cooling the wafer W before and after the photoresist coating process. The coating module 401 includes a resist coating chamber 410, a bake chamber 420, and a return chamber 430. The resist coating chamber 410, bake chamber 420, and return chamber 430 are sequentially arranged in the second direction 14. Therefore, the resist coating chamber 410 and the bake chamber 420 are spaced apart from each other in the second direction 14 with the return chamber 430 interposed therebetween. A plurality of the resist coating chambers 410 are arranged in each of the first and third directions 12 and 16. In the drawings, six resist coating chambers 410 are exemplarily provided. A plurality of the bake chambers 420 are arranged in each of the first and third directions 12 and 16. In the drawings, six bake chambers 420 are exemplarily provided. However, six or more bake chambers 420 may be provided.

The return chambers 430 are located side by side with the first buffer 320 of the first buffer module 300 in the first direction 12. The coating robot 432 and the guide rail 433 are disposed in the return chamber 430. The return chamber 430 is generally formed in a rectangular shape. The developing robot 432 transfers the wafer W between the bake chambers 420, the resist coating chambers 400, the first buffer 320 of the first buffer module 300, and a first cooling chamber 520 of the second buffer module 500, which will be described later. The guide rail 433 has a length direction extending in the first direction 12. The guide rail 433 guides the linear movement of the developing robot 432 in the first direction 12. The developing robot 432 has a hand 434, an arm 435, a support 436, and a base 437. The hand 434 is fixedly installed on the arm 435. The arm 435 is configured to be capable of expanding and contracting so that the hand 434 can move in the horizontal direction. The support 436 is disposed such that a length direction thereof extends in the third direction 16. The arm 435 is coupled to the support 436 to be capable of linearly moving along the support 436 in the third direction 16. The support 436 is fixedly coupled to the base 437 and the base 437 is coupled to the guide rail 433 to be capable of moving along the guide rail 433.

All of the resist coating chambers 410 have a same structure. However, types of the photoresist used in the respective resist coating chambers 410 may be different from each other. For example, chemically amplified resist may be used as the photoresist. The resist coating chambers 410 coat the photoresist on the wafers W. The resist coating chamber 410 includes a housing 411, a support plate 412, and a nozzle 413. The housing 411 is formed in a cup shape having an opened top. The supporting plate 412 is located in the housing 411 to support the wafer W. The supporting plate 412 is configured to be capable of rotating. The nozzle 413 supplies the photoresist onto the wafer W on the supporting plate 412. The nozzle 413 is formed in a circular tube shape to supply the photoresist to a center of the wafer W. The nozzle 413 may have a length corresponding to a diameter of the wafer W and have a slit-type outlet. In addition, the resist coating chamber 410 may further include a nozzle 414 for supplying cleaning liquid such as deionized water for cleaning a surface of the wafer W on which the photoresist is coated.

The bake chambers 420 heat-treat the wafers W. For example, the bake chambers 420 perform a pre-bake process for removing organic matters or moisture from the surfaces of the wafers W by heating the wafers W at a predetermined temperature before coating the photoresist on the wafers W, a soft bake process performed after coating the photoresist on the wafers W. The bake chambers 420 further perform cooling processes after the respective heating processes. The bake chamber 420 includes a cooling plate 421 or a heating plate 422. The cooling plate 421 is provided with a cooling element 423 such as cooling water or thermoelectric module. The heating plate 422 is provided with a heating element 424 such as a heating wire or a thermoelectric module. The heating plate 422 and the cooling plate 421 may be provided in the respective bake chambers 420. Alternatively, some of the bake chambers 420 may be provided with only the cooling plate 421 and the rest may be provided with only the heating plate 422.

The developing module 402 performs a developing process for partly removing the photoresist on the wafer W to form a pattern by supplying a developing solution and heat treatment processes such as heating and cooling processes performed before and after the developing process. The developing module 402 includes a developing chamber 460, a bake chamber 470, and a return chamber 480. The developing chamber 460, bake chamber 470, and return chamber 480 are sequentially arranged in the second direction 14. Therefore, the developing chamber 460 and the bake chamber 470 are spaced apart from each other in the second direction with the return chamber 480 interposed therebetween. A plurality of the developing chambers 460 are arranged in each of the first and third directions 12 and 16. In the drawings, six developing chambers 460 are exemplarily provided. A plurality of the bake chambers 470 are arranged in each of the first and third directions 12 and 16. In the drawings, six bake chambers 470 are exemplarily provided. However, six or more bake chambers 470 may be provided.

The return chambers 480 are located side by side with the second buffer 330 of the first buffer module 300 in the first direction 12. The developing robot 482 and the guide rail 483 are disposed in the return chamber 480. The return chamber 480 is generally formed in a rectangular shape. The developing robot 482 transfers the wafer W between the bake chambers 470, the developing chambers 460, the second buffer 330 of the first buffer module 300, and the second cooling chamber 540 of the second buffer module 500. The guide rail 483 has a length direction extending in the first direction 12. The guide rail 483 guides the linear movement of the developing robot 482 in the first direction 12. The developing robot 482 has a hand 484, an arm 483, a support 486, and a base 487. The hand 484 is fixedly installed on the arm 485. The arm 485 is configured to be capable of expanding and contracting so that the hand 484 can move in the horizontal direction. The support 486 is disposed such that a length direction thereof extends in the third direction 16. The arm 485 is coupled to the support 486 to be capable of linearly moving along the support 486 in the third direction 16. The support 486 is fixedly coupled to the base 487 and the base 487 is coupled to the guide rail 483 to be capable of moving along the guide rail 483.

All of the resist coating chambers 460 have a same structure. However, types of the photoresist used in the respective resist coating chambers 410 may be different from each other. The developing chamber 460 removes an exposed region of the photoresist on the wafer W. At this point, an exposed region of the protective layer is removed together. Alternatively, unexposed regions of the photoresist and protective layer may be removed.

The developing chamber 460 includes a housing 461, a support plate 462, and a nozzle 463. The housing 461 is formed in a cup shape having an opened top. The supporting plate 462 is located in the housing 461 to support the wafer W. The supporting plate 462 is configured to be capable of rotating. The nozzle 463 supplies the developing solution onto the wafer W on the supporting plate 462. The nozzle 463 is formed in a circular tube shape to supply the photoresist to a center of the wafer W. The nozzle 463 may have a length corresponding to a diameter of the wafer W and have a slit-type outlet. In addition, the developing chamber 460 may further include a nozzle 464 for supplying cleaning liquid such as deionized water for cleaning a surface of the wafer W on which the developing solution is supplied.

The bake chambers 470 heat-treat the wafers W. For example, the bake chambers 470 perform a post-bake process for heating the wafer W before the developing process and a hard bake process for heating the wafer after the developing process. The bake chambers 470 further perform cooling processes after the respective heating processes. The bake chamber 470 includes a cooling plate 471 or a heating plate 472. The cooling plate 471 is provided with a cooling element 473 such as cooling water or a thermoelectric module. The heating plate 472 is provided with a heating element 474 such as a heating wire or a thermoelectric module. The heating plate 472 and the cooling plate 471 may be provided in the respective bake chambers 470. Alternatively, some of the bake chambers 470 may be provided with only the heating plate 472 and the rest may be provided with only the cooling plate 471.

As described above, the developing module 400 and the coating module 401 are separated from each other. In addition, when viewed from above, the coating module 401 and the developing module 402 may have a same chamber arrangement.

(Second Buffer Module)

The second buffer module 500 is provided as a passageway for transferring the wafer W between the coating/developing module 400 and the pre/post-exposure treatment module 600. In addition, the second buffer module 500 performs processes such as a cooling process and an edge exposure process for the wafer W. The second buffer module 500 includes a frame 510, a buffer 520, a first cooling chamber 530, a second cooling chamber 540, an edge exposure chamber 550, and a second buffer robot 560. The frame 510 is formed in a rectangular shape. The buffer 520, first cooling chamber 530, second cooling chamber 540, edge exposure chamber 550, and second buffer robot 560 are disposed in the frame 510. The buffer 520, first cooling chamber 530, and edge exposure chamber 550 are arranged at a height corresponding to the coating module 401. The second cooling chamber 540 is arranged at a height corresponding to the developing module 402. The buffer 520, first cooling chamber 530, and second cooling chamber 540 are sequentially arranged in a line extending in the third direction. When viewed from above, the buffer 520 and the return chamber 430 of the deposition module 401 are arranged in the first direction 12. The edge exposure chamber 550 is spaced apart from one of the buffer 520 and first cooling chamber 530 in the second direction 14 by a predetermined distance.

The second buffer robot 560 transfers the wafer W between the buffer 520, first cooling chamber 530, and edge exposure chamber 550. The second buffer robot 560 is located between the edge exposure chamber 550 and the buffer 520. The second buffer robot 560 may have a similar structure to the first buffer robot 360. The first cooling chamber 530 and the edge exposure chamber 550 perform processes for the wafer W that is processed in the coating module 401. That is, the first cooling chamber 530 cools the wafer W that is processed in the coating module 401. The first cooling chamber 530 has a similar structure to the cooling chamber 350 of the first buffer module 300. An edge of the wafer W that is processed in the first cooling chamber 530 is exposed in the edge exposure chamber 550. The buffer 520 temporarily stores the wafers W that are processed in the edge exposure chamber 550 before the wafers W are transferred to a pre-treatment module 601. The second cooling chamber 540 cools the wafers W that are processed in a post-treatment module 602, which will be described later, before the wafers W are transferred to the developing module 402. The second buffer module 500 may further include another buffer located at a height corresponding to the developing module 402. In this case, the wafers W that are processed in the post-treatment module 602 may be transferred to the developing module 402 after being temporarily stored in the another buffer.

(Pre/Post-Exposure Treatment Module)

The pre/post-exposing treatment unit 600 performs a process performed between the first process and the exposure process and a process performed between the exposure process and the second process. For example, when the exposure unit 900 performs a liquid immersion lithography process, the pre/post-exposure treatment unit 600 may perform a process for coating a protective layer that protects the photoresist coated on the wafer W during the liquid immersion lithography process. In addition, the pre/post exposure treatment unit 600 may perform a process for cleaning the wafer after the exposure process. In addition, when chemically amplified resist is used in the coating process, the pre/post-exposure treatment module 600 may perform a post-exposure bake process.

The pre/post-exposure treatment module 600 includes a pre-treatment module 601 and a post-treatment module 602. The pre-treatment module 601 performs a process for treating the wafer W before the exposure process and the post-treatment module 602 performs a process for treating the wafer after the exposure process. The pre-treatment module 601 and the post-treatment module 602 are disposed at different layers. For instant, the pre-treatment module 601 is disposed above the post-treatment module 602. The pre-treatment module 601 has the same height as the coating module 401. The post-treatment module 602 has the same height as the developing module 402. The pre-treatment module 601 includes a protective coating chamber 601, a bake chamber 620, and a return chamber 630, which are sequentially arranged in the second direction 14. Hence, the protective coating chamber 610 is spaced apart from the bake chamber 620 with the return chamber 630 interposed therebetween. A plurality of the protective coating chambers 610 are provided and stacked one another in the third direction 16. Alternatively, a plurality of the protective layer coating chambers 610 may be arranged in each of the first and third directions 12 and 16. A plurality of the bake chambers 620 are provided and staked one another in the third direction. Alternatively, a plurality of the bake chambers 620 may be arranged in each of the first and third directions 12 and 16.

The return chamber 630 is located side by side with the first cooling chamber 530 of the second buffer module 500 in the first direction 12. The pre-treatment robot 632 is located in the return chamber 630. The return chamber 630 is generally formed in a square or rectangular shape. The pre-treatment robot 632 transfers the wafer W between the protective layer coating chambers 610, bake chambers 620, buffer 520 of the second buffer module 500, and a first buffer 720 of the interface module 700, which will be described later. The pre-treatment robot 632 includes a hand 633, an arm 634, and a support 635. The hand 633 is fixedly installed on the arm 634. The arm 634 is configured to be capable of expanding, contracting, and rotating. The arm 634 is coupled to the support 635 to be capable of linearly moving along the support 635 in the third direction 16.

The protective layer coating chamber 610 coats the protective layer on the wafer W to protect the resist layer during the liquid immersion lithography process. The protective layer coating chamber 610 includes a housing 611, a support plate 612, and a nozzle 613. The housing 611 is formed in a cup shape having an opened top. The support plate 612 is located in the housing and supports the wafer W. The support plate 612 is designed to be rotatable. The nozzle 613 supplies protective liquid for the protective layer onto the wafer W. The nozzle 613 may be formed in a circular tube shape and supply the protective liquid to the center of the wafer W. Selectively, the nozzle 613 has a length corresponding to the diameter of the wafer W and provided with a slit-type outlet. In this case, the support plate 612 may be provided in a fixed state. The protective liquid includes a foaming material. The protective liquid may be a material that has a low affinity with the photoresist and fire. For example, the protective liquid may include a fluorine-based solvent. The coating of the protective liquid by the protective layer coating chamber 610 starts from the central region of the wafer W while the wafer W on the support plate 612 rotates.

The bake chamber 620 heat-treats the wafer W on which the protective layer is coated. The bake chamber 620 has at least one of a cooling plate 621 and a heating plate 622. The cooling plate 621 is provided with a cooling element 623 such as cooling water or a thermoelectric module. The heating plate 622 is provided with a heating element 624 such as a heating wire or a thermoelectric module. Each of the heating plate 622 and the cooling plate 621 may be provided in one bake chamber 4420. Alternatively, some of the bake chambers 620 may have only the heating plate 622 and the rest may have only the cooling plate 621.

The post-treatment module 602 includes a cleaning chamber 660, a post-exposure bake chamber 770, and a return chamber 680. The cleaning chamber 660, return chamber 680, and post-exposure bake chamber 670 are sequentially arranged along a line extending in the second direction 14. Therefore, the cleaning chamber 660 and the post-exposure bake chamber 670 are spaced apart from each other in the second direction 14 with the return chamber 680 interposed therebetween. A plurality of the cleaning chambers 660 are provided and disposed, at different layers in the third direction 16. Alternatively, a plurality of the cleaning chambers 660 may be arranged in each of the first and third directions 12 and 16. A plurality of the post-exposure bake chambers 670 are provided and disposed at different layers along a ling extending in the third direction 16. Alternatively, a plurality of the post-exposure bake chambers 670 may be arranged in each of the first and third directions 12 and 16.

The return chamber 680 is arranged side by side with the second cooling chamber 540 of the second buffer module 500 in the first direction 12 when viewed from above. The return chamber 680 is generally formed in a square shape or a rectangular shape. The post-treatment robot 682 is located within the return chamber 680. The post-treatment robot 682 is configured to transfer the wafer W between the post-exposure bake chambers 670, second cooling chamber 540 of the second buffer module 500, and a second buffer 730 of the interface module 700, which will be described later. The post-treatment robot of the post-treatment module 602 may has the same structure as the pre-treatment robot 632 of the pre-treatment module 601.

The cleaning chamber 660 cleans the wafer W after the exposure process. The cleaning chamber 660 includes a housing 661, a support plate 662, and a nozzle 663. The housing 661 is formed in a cup shape having an opened top. The support plate 662 is located within the housing 661 and supports the wafer W. The support plate 662 is rotatably provided. The nozzle 663 supplies cleaning liquid to the wafer W on the support plate 662. The cleaning liquid may be water such as deionized water. The cleaning chamber 660 supplies the cleaning liquid to the central region of the wafer W while rotating the wafer W on the support plate 662. As the wafer W rotates, the nozzle 663 may linearly move or rotate from the central region to the peripheral region of the wafer W.

The post-exposure bake chamber 670 heats the wafer W that is treated in the exposure process using deep ultraviolet. The post-exposure bake process completes a property variation by amplifying acid, which is generated by exposing the photoresist, by heating the wafer W. The post-exposure bake chamber 670 has a heating plate 672. The heating plate 672 is provided with a heating element 672 such as a heating wire or a thermoelectric module. The post-exposure chamber 670 may further include a cooling plate 671. The cooling plate 671 is provided with a cooling element 673 such as cooling water and a thermoelectric module. Alternatively, a bake chamber having only the cooling plate 4471 may be further provided.

In the above-described pre/post-exposure treatment module 600, the pre-treatment and post-treatment modules 601 and 602 are completely separated from each other. In addition, the return chamber 630 of the pre-treatment module 601 has the same size as the return chamber 680 of the second module 602 so that they can completely overlap with each other when viewed from above. In addition, the protective layer coating chamber 610 has the same size as the cleaning chamber 660 so that the protective layer coating chamber 610 and the cleaning chamber 660 completely overlap with each other when viewed from above. Further, the bake chamber 620 has the same size as the post-exposure bake chamber 670 so that they completely overlap with each other when viewed from above.

(Interface Module)

The interface module 700 transfers the wafer W between the pre/post-exposure treatment module 600 and the exposure unit 900. The interface module 700 includes a frame 710, a first buffer 720, a second buffer 730, and an interface robot 740. The interface robot 740, first buffer 720, and second buffer 730 are located within the frame 710. The first and second buffers 720 and 730 are spaced apart from each other and stacked one another. The first buffer 720 is disposed above the second buffer 730. The first buffer 720 is disposed at a height corresponding to the pre-treatment module 601. The second buffer 730 is disposed at a height corresponding to the post-treatment module 602. When viewed from above, the first buffer 720 is arranged inline with the return chamber 630 of the pre-treatment module 601 in the first direction 12. The second buffer 730 is arranged inline with the return chamber 4430 of the post-treatment module 602 in the first direction 12.

The interface robot 740 is spaced apart from the first and second buffers 720 and 730 in the second direction 14. The interface robot 740 transfers the wafer W between the first buffer 720, second buffer 730, and exposure unit 900. The interface robot 740 has a similar structure to the second buffer robot 560.

The first buffer 720 temporarily stores the wafers W that are processed in the pre-treatment module 601 before the wafers W are transferred to the exposure unit 900. The second buffer 730 temporarily stores the wafers W that are processed in the exposure unit 900 before the wafers W are transferred to the post-treatment module 602. The first buffer 720 has a housing 721 and a plurality of supports 722. The supports 722 are disposed within the housing 721 and spaced apart from each other in the third direction 16. One wafer W is disposed on each of the supports 722. The housing 721 is provided with openings respectively corresponding to the interface robot 740 and the pre-treatment robot 632 so that the interface robot 740 and the pre-treatment robot 632 can carry and take out the wafer W to and from the supports 722 in the housing 721. The second buffer 730 has a similar structure to the first buffer 720. However, the housing 731 of the second buffer 730 is provided with openings (not shown) respectively corresponding to the interface robot 740 and the post-treatment robot 682. The number of the supports 722 of the first buffer 720 may be same as or different from that of the supports 732 of the second buffer 730.

(Process)

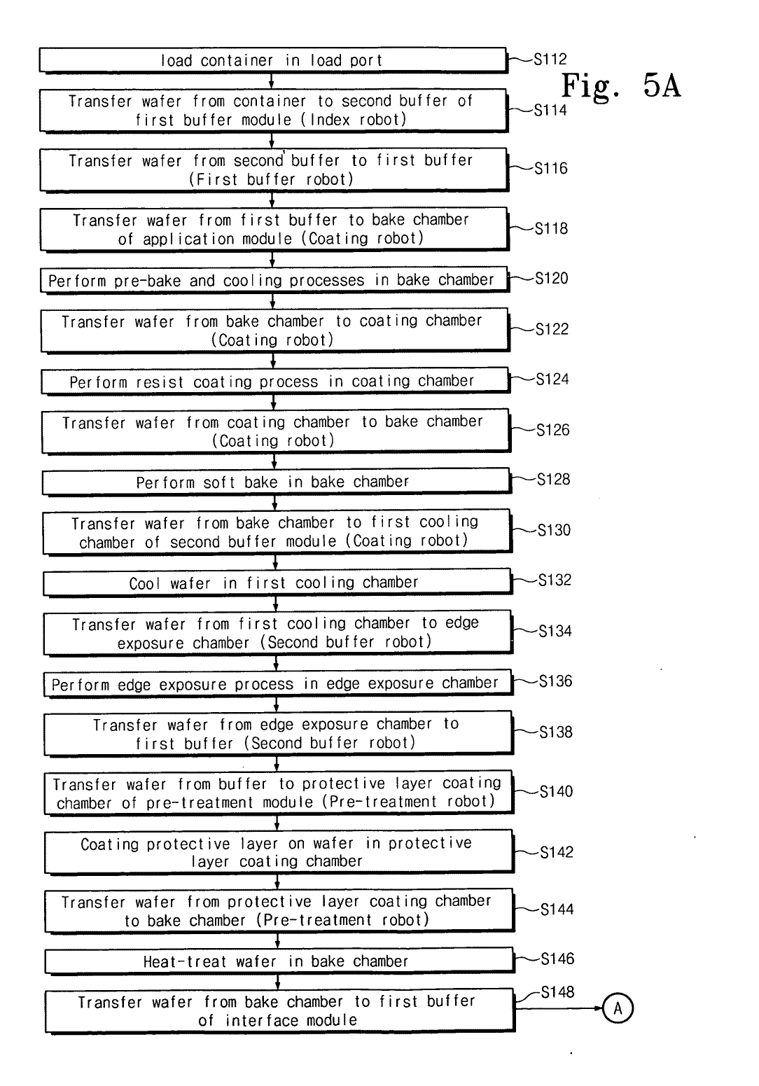

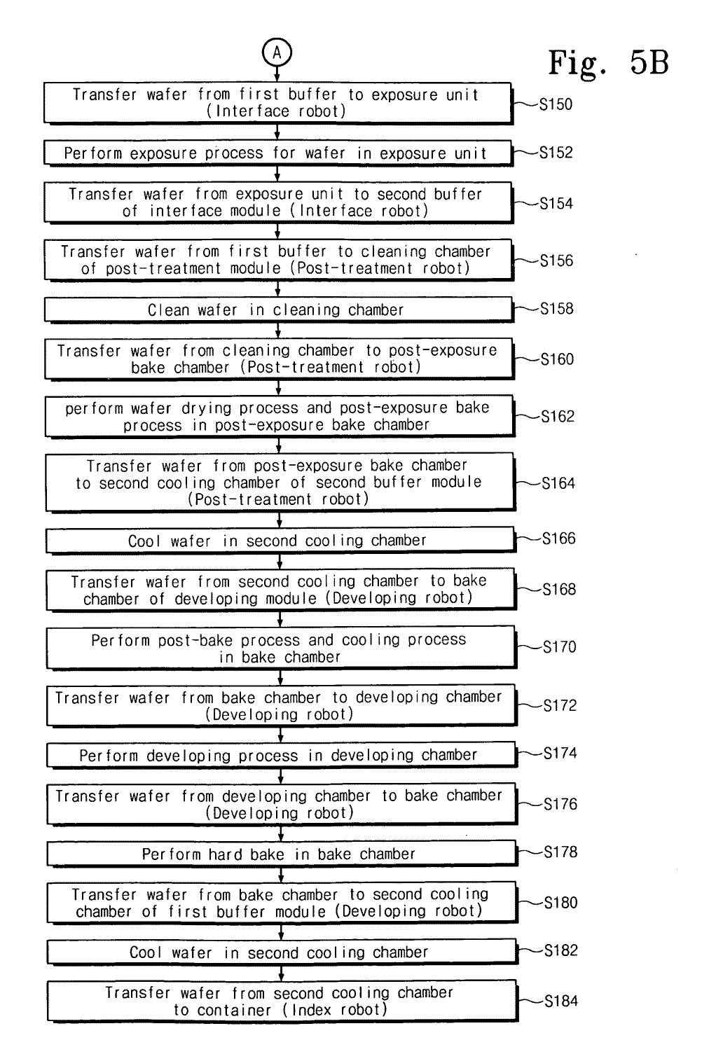

The following will describe a process performed by the substrate treatment apparatus 1 of FIG. 1 according to one embodiment. FIGS. 5a and 5b are flowcharts illustrating a process for the wafer W in the substrate treatment apparatus 1.

The container 20 receiving the wafers W is loaded on the load table 120 of the load port 100 (S112). The door of the container 20 is opened by the door opener. The index robot 220 takes out the wafer W from the container 20 and carries the same to the second buffer 330 (S114).

The first buffer robot 360 transfers the wafer W from the second buffer 330 to the first buffer 320 (S116). The coating robot 432 transfers the wafer W from the first buffer 320 to the bake chamber 420 of the coating module 401 (S118). The bake chamber 420 sequentially performs the pre-bake process and the cooling process (S120). The coating robot 432 takes out the wafer from the bake chamber 420 and carries the same to the resist coating chamber 410 (S122). The resist coating chamber 410 coats the photoresist on the wafer W (S124). Next, the coating robot 432 transfers the wafer W from the resist coating chamber 410 to the bake chamber 420 (S126). The bake chamber 420 performs the soft bake process for the wafer W (S128).

The coating robot 432 takes out the wafer W from the bake chamber 420 and carries the same to the first cooling chamber 530 of the second buffer module 500 (S130). The cooling process is performed for the wafer W in the first cooling chamber 530 (S132). The wafer W processed in the first cooling chamber 530 is transferred to the edge exposure chamber 550 by the second buffer robot 560 (S134). The edge exposure chamber 550 performs a process for exposing the peripheral region of the wafer W (S136). The wafer W processed in the edge exposure chamber 550 is transferred to the buffer 520 by the second buffer robot 560 (S138).

The pre-treatment robot 632 takes out the wafer W from the buffer 520 and carries the same to the pre-treatment module 601 (S140). The protective coating chamber 610 coats the protective layer on the wafer W (S142). Next, the pre-treatment robot 632 takes out the wafer W from the protective layer coating chamber 610 and carries the same to the bake chamber 620 (S144). The bake chamber 620 performs a heat-treatment process such as a heating process and a cooling process (S146).

The pre-treatment robot 632 takes out the wafer W from the bake chamber 620 and carriers the same to the first buffer 720 of the interface module 700 (A148). The interface robot 740 transfers the wafer W from the first buffer 720 to the exposure unit 900 (S150). The wafer W is exposed in the exposure unit 900 (S152). Next, the interface robot 740 transfers the wafer W from the exposure unit 900 to the second buffer 730 (S154).

The post-treatment robot 682 takes out the wafer from the second buffer 730 and carries the same to the cleaning chamber 660 of the post-treatment module 602 (S156). The cleansing chamber 660 supplies the cleaning liquid to the surface of the wafer W to perform the cleaning process for the wafer W (S158). When the cleaning of the wafer W by the cleaning liquid is completed, the post-treatment robot 682 takes out the wafer W from the cleaning chamber 600 and carries the same to the wafer W of the post-exposure bake chamber 670 (S160). The cleaning liquid adhered to the wafer W is removed by the heating plate 672 heating the wafer W and, at the same time, the acid generated in the photoresist is amplified to complete the property variation of the photoresist (S162). The post-treatment robot 682 transfers the wafer W from the post-exposure bake chamber 670 to the second cooling chamber 540 of the second buffer module 500 (S164). The wafer W is cooled in the second cooling chamber 540 (S166).

The developing robot 482 takes out the wafer from the second cooling chamber 540 to the bake chamber 470 of the developing module 402 (S168). The bake chamber 470 sequentially performs the post-bake process and the cooling process (S170). The developing robot 482 takes out the wafer W from the bake chamber 470 and carries the same to the developing chamber 460 (S172). The developing chamber 460 performs the developing process by supplying the developing solution to the wafer W (S174). Next, the developing robot 482 transfers the wafer W from the developing chamber 460 to the bake chamber 470 (S176). The bake chamber 470 performs the hard bake process for the wafer W (S178).

The developing robot 482 takes out the wafer W from the bake chamber 470 and carries the same to the cooling chamber 350 of the first buffer module 300 (S180). The cooling chamber 350 performs the process for cooling the wafer W (S182). The index robot 360 transfers the wafer W from the cooling chamber 350 to the container 20 (S184). Alternatively, the developing robot 482 transfers the wafer from the bake chamber 470 to the first buffer module 300 and then the wafer W may be transferred to the container 20 by the index robot 360.

According to the embodiment of FIG. 1, the pre/post-exposure treatment module 600 is disposed between the coating/developing module 400 and the interface module 700. Therefore, the processes required before and after the exposure process can be performed immediately before and after the exposure process.

In addition, no protective layer removal chamber is provided in the pre/post-exposure treatment module 600. Therefore, the structure of the pre/post-exposure treatment unit 600 is relatively simple and the time for performing the process can be reduced.

In addition, when the chemically amplified resist is used, the timing for performing the post-exposure baking process after the exposure process is performed is important. According to the embodiment of FIG. 1, the post-exposure bake chamber 670 is provided to the pre/post-exposure treatment unit 600. Accordingly, the amplifying of the acid in the pre/post-exposure treatment unit 600 can be quickly realized before the wafer W is transferred to the developing module 402.

Further, according to the embodiment of FIG. 1, the cleaning chamber 660 performs only the cleaning process for the wafer W using the cleaning liquid. That is, the cleaning chamber 660 does not perform the drying process for the wafer W using drying gas. The drying of the wafer W is performed by heating the wafer W. For example, the drying of the wafer W is performed simultaneously with the acid amplification in the post-exposure bake chamber 670. Accordingly, the process time can be reduced as compared with a case where the cleaning and drying of the wafer are preformed in the cleaning chamber 660.

### Modified Examples

The following will describe a variety of modified examples of the substrate treatment apparatus 1.

The index robot 220 may be configured to directly transfer the wafers W to the first buffer 320.

The cooling chambers 350 may be stacked one another in the first buffer module 300. In addition, a plurality of the first cooling chamber 530, a plurality of the second cooling chambers 540, and a plurality of the edge exposure chambers 550 may be provided in the second buffer module 500.

In addition, no cooling chamber 350 may be provided in the first buffer module 300. In this case, the wafer W may be directly transferred from the coating module 401 to the first buffer 320 by the coating robot 432 and the index robot 220 may transfer the wafers W stored in the first buffer 320 to the container 20. Further, the wafer W may be transferred from the developing module 402 to the second buffer 330 by the developing robot 482 and the index robot 220 may transfer the wafers W stored in the second buffer 330 to the container 20.

Further, in the first buffer module 300, the locations of the first buffer module 300 and the cooling chamber 350 may be exchanged.

In addition, the coating/developing module 400 may include only one module instead of the coating and developing modules 401 and 402 that are disposed at different layers. In this case, all of the coating chamber, developing chamber, bake chamber, and return chamber may be provided in the module. In this case, no the first buffer 320 and the first buffer robot 360 may be provided in the first buffer module 300,

Further, no first cooling chamber 530 may be provided in the second buffer module 500. In this case, the wafer W processed in the coating module 401 is directly transferred to the buffer 520 by the coating robot 432. In addition, no second cooling chamber 540 is provided in the second buffer module 500 and an additional buffer may be provided in the second buffer module 500. In this case, the wafer W processed in the post-treatment module 602 may be transferred to the additional buffer by the post-treatment robot 682.

In addition, no second buffer module 500 may be provided and the pre/post exposure treatment module 600 may be disposed adjacent to the coating/developing module 400.

The pre/post-exposure treatment module 600 may be provided with only one module instead of the pre-treatment and post-treatment modules 601 and 602. In this case, all of the protective layer coating chamber 610, bake chamber 620, cleaning chamber 660, post-exposure bake chamber 670 may be provided in the module.

The cleaning liquid adhered to the wafer after cleaning the wafer W may be removed in other chambers rather than the post-exposure bake chamber 670.

In addition, the cleaning chamber 660 may further includes a nozzle for supplying drying gas in addition to the nozzle for supplying the cleaning liquid. In this case, the cleaning liquid adhered to the wafer W can be removed before the wafer W is heated in the post-exposure bake chamber 670.

Further, no cooling plate may be provided in the post-treatment module 602. The cooling of the wafer W may be realized only in the cooling chamber of the second buffer module 500. In this case, a plurality of the cooling chambers may be disposed in the second buffer module 500 and stacked one another.

In addition, the locations of the pre-treatment and post-treatment modules 601 and 602 may be exchanged. In this case, coating module 401 and the developing module 402 may be provided at respective heights that respectively correspond to the pre-treatment and post-treatment modules 601 and 602.

Further, a protective layer removal chamber for removing the protective layer after the exposure process may be provided in the post-treatment module 602. In this case, the protective layer on the wafer W may be removed in advance before the developing process or ashing process.

In addition, when the exposure unit 900 performs a process using a method other than the liquid immersion lithography method, no protective layer coating chamber 610 may provided in the pre-treatment module 601. In this case, the pre/post-exposure treatment module 600 may include only the post-treatment module 602 without the pre-treatment module 602.

In addition, when the exposure unit 900 uses a light source other than the deep ultraviolet light source, no post-exposure bake chamber 670 may be provided in the post-treatment module 602.

In addition, the edge exposure chamber 550 may be provided in the interface module 700. Further, the edge exposure process may be performed after the protective layer coating process or between the exposure process and the wafer cleaning process. Alternatively, the edge exposure process may be preformed between the post-exposure bake process and the developing process.

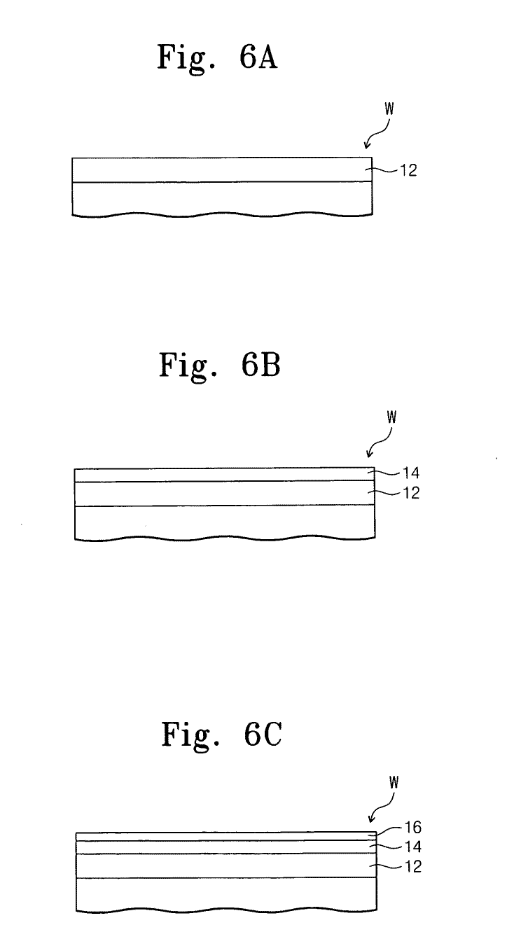

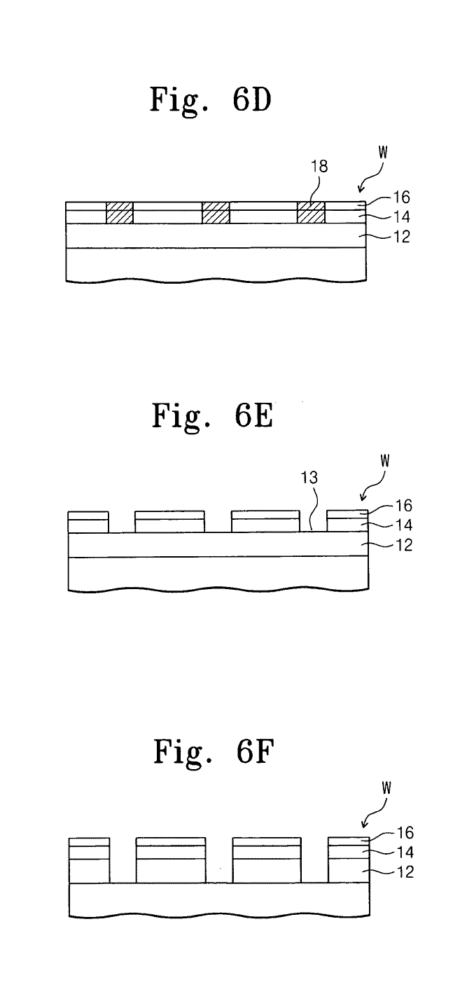

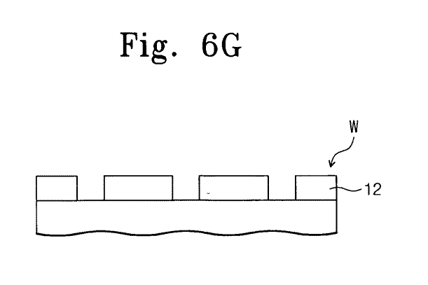

FIGS. 6a and 6g are views illustrating sequential processes for forming a pattern on a thin film formed on the wafer W.

First, a thin film 12 is deposited on the wafer W in a deposition unit (not shown) (see FIG. 6a). The wafer W is transferred to the substrate treatment apparatus 1. In the coating module 401, a photoresist 14 is coated on the wafer W (see FIG. 6b). In the coating unit 401, other processes such as the bake process and the like are further processed. Next, the protective layer 16 is coated on the wafer W in the pre-treatment module 601 of the pre/post-exposure treatment unit 600 (see FIG. 6c). As previously described, other processes such as the bake process and the like are further performed in the pre-treatment module 601. The wafer W is carried to the exposure unit 900. The exposure unit 900 irradiates light to a selected region 18 on the protective layer 16 and the photoresist 14 to change the property of the selected region 18 (see FIG. 6d). The post-treatment module 602 of the pre/post-exposure treatment unit 600 performs the cleaning process, the post-exposure bake process, and the like. The cleaning liquid remaining on the wafer W is removed during the post-exposure bake process. The selected region 18 of the protective layer 16 and the photoresist 14, which is changed in its property, is removed in the developing module 402 (see FIG. 6e). As previously described, the developing module 402 further performs other processes such as the bake process and the like in addition to the developing process. Next, the wafer W is transferred to the etching unit (not shown). The exposed region 13 of the thin film is removed in the etching unit (see FIG. 60. Next, the wafer W is transferred to the ashing unit (not shown). The photoresist 14 and the protective layer 106 that remains on the thin film are removed in the ashing unit (see FIG. 6g). While the wafer is transferred between the deposition unit, substrate treatment apparatus 1, etching unit and ashing unit, other processes such as the process for cleaning the wafer W and the like may be further performed.

According to the embodiments, the photolithography process can be efficiently performed.

Further, when the chemically amplified photoresist is used, the post-exposure bake process can be quickly performed.

In addition, since the cleaning liquid remaining on the substrate can be removed by amplifying acid in the post-exposure bake unit without using a separate drying nozzle in the cleaning chamber, the process time can be reduced.

Furthermore, since the protective layer is removed in the developing process and the ashing process without using a separate protective removable chamber in the pre/post-exposure treatment unit, the process time can be reduced.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. An apparatus for treating a substrate, comprising:
a load port in which a container receiving the substrates is disposed;
a first buffer module having a buffer for temporarily storing the substrates;
an index module transferring the substrate between the load port and the first buffer module;
a coating/developing module for performing a photoresist coating process and a developing process for the substrate;
a second buffer module having a buffer for temporarily storing the substrates;
a pre/post-exposure treatment module performing processes for the substrate between the photoresist coating process and an exposure process and between the exposure process and the developing process; and
an interface module connected to an exposure module,
wherein the load port, index module, first buffer module, coating/developing module, second buffer module, pre/post-exposure treatment module, interface module are arranged in a line extending in a first direction.

2. The apparatus of claim 1, wherein the pre/post-exposure treatment module comprises a protective layer coating chamber coating a protective layer on the substrate.

3. The apparatus of claim 2, wherein the pre/post-exposure treatment module further comprises a cleaning chamber cleaning the substrate.

4. The apparatus of claim 3, wherein the pre/post-exposure treatment module comprises a pre-treatment module and a post-treatment module that are disposed at different layers, wherein the protective layer coating chamber is disposed in the pre-treatment module and the cleaning chamber is disposed in the post-treatment module.

5. The apparatus of claim 4, wherein the pre-treatment module further comprises a bake chamber performing a bake process for the substrate and a pre-treatment robot transferring the substrate between the bake chamber and the protective layer coating chamber; and
the post-treatment module further comprises a post-exposure bake chamber performing a bake process for the substrate after the exposure process and a post-treatment robot transferring the substrate between the cleaning chamber and the post-exposure bake chamber.

6. The apparatus of claim 5, wherein the second buffer module further comprises an edge exposure chamber exposing an edge of the substrate and a second buffer robot transferring the substrate to the edge exposure chamber.

7. The apparatus of claim 5, wherein the second buffer module further comprises a cooling chamber cooling the substrate.

8. The apparatus of claim 5, wherein the coating/developing module comprises a coating module and a developing module, which are disposed at different layers;
the coating module comprises a coating chamber coating the photoresist on the substrate, a bake chamber heat-treating the substrate, and a coating robot transferring the substrate between the bake chamber of the coating module and the coating chamber; and
the developing module comprises a developing chamber performing the developing process for the substrate, a bake chamber heat-treating the substrate, and a developing robot transferring the substrate between the bake chamber of the developing module and the developing chamber.

9. The apparatus of claim 8, wherein the coating module is located at a same height as the pro-treatment module, and the developing module is located at a same height as the post-treatment module.

10. The apparatus of claim 9, wherein the second buffer module comprises a cooling chamber performing a cooling process for the substrate;
the buffer of the second buffer module is located at a height corresponding to the coating module; and
the cooling chamber is located at a height corresponding to the developing module.

11. The apparatus of claim 5, wherein the interface module comprises:
a first buffer disposed at a height corresponding to the post-treatment module and temporarily storing the substrate;
a second buffer disposed at a height corresponding to the pre-treatment module and temporarily storing the substrate; and
an interface robot transferring the substrate between the first buffer and the exposure unit and between the second buffer and the exposure unit.

12. The apparatus of claim 5, wherein the protective layer coating chamber, a return chamber provided with the pre-treatment robot, and the bake chamber of the pre-treatment module are sequentially arranged in a second direction perpendicular to the first direction when viewed from above; and
the cleaning chamber, a return chamber provided with the post-treatment robot, and the post-exposure bake chamber are sequentially arranged in the second direction when viewed from above.

13. The apparatus of claim 12, wherein each of the return chamber provided with the pre-treatment robot and the return chamber provided with the post-treatment robot is arranged side by side with the buffer of the second buffer module in the first direction.

14. The apparatus of claim 13, wherein the coating/developing module comprises a coating module and a developing module, which are disposed at different layers;
the coating module comprises a coating chamber coating a photoresist on the substrate, a bake chamber heat-treating the substrate, a return chamber provided with a coating robot transferring substrate between the bake chamber of the coating module and the coating chamber;
the developing module comprises a developing chamber performing the developing process for the substrate, a bake chamber heat-treating the substrate, a return chamber provided with a developing robot transferring the substrate between the bake chamber of the developing module and the developing chamber; and
each of the return chamber provided with the coating robot and the return chamber provided with the developing robot is arranged side by side with the buffer of the second buffer module in the first direction when viewed from above.

15. The apparatus of claim 13, wherein the second buffer module further comprises an edge exposure chamber exposing an edge of the substrate and a second buffer robot transferring the substrate to the edge exposure chamber; and
the buffer of the second buffer module, the second buffer robot, and the edge exposure chamber are sequentially arranged in a second direction perpendicular to the first direction when viewed from above.

16. An apparatus for treating a substrate, comprising:
a load port in which a container receiving the substrates is disposed;
an index module transferring the substrate with respect to the container loaded in the load port;
a coating/developing module for performing a photoresist coating process and a developing process for the substrate; and
a pre/post-exposure treatment module performing processes for the substrate between the photoresist coating process and an exposure process and between the exposure process and the developing process,
wherein, the load port, index module, coating/developing module, and pre/post-exposure treatment module are arranged in a line extending in a first direction.

17. The apparatus of claim 16, wherein the pre/post-exposure treatment module comprises a protective layer coating chamber coating a protective layer on the substrate.

18. The apparatus of claim 16, wherein the pre/post-exposure treatment module further comprises a cleaning chamber cleaning the substrate.

19. The apparatus of claim 16, wherein the pre/post-exposure treatment module comprises a pre-treatment module and a post-treatment module that are disposed at different layers, wherein the pre-treatment module comprises a protective layer coating chamber coating the protective layer on the substrate and the post-treatment module comprises a cleaning chamber cleaning the substrate.

20. The apparatus of claim 19, wherein the pre-treatment module further comprises a bake chamber performing a bake process for the substrate and a pre-treatment robot transferring the substrate between the bake chamber and the protective layer coating chamber; and
the post-treatment module further comprises a post-exposure bake chamber performing a bake process for the substrate after the exposure process and a post-treatment robot transferring the substrate between the cleaning chamber and the post-exposure bake chamber.

21. The apparatus of claim 20, wherein the coating/developing module comprises a coating module and a developing module, which are disposed at different layers;
the coating module comprises a coating chamber coating the photoresist on the substrate, a bake chamber heat-treating the substrate, and a coating robot transferring the substrate between the bake chamber of the coating module and the coating chamber; and
the developing module comprises a developing chamber performing the developing process for the substrate, a bake chamber heat-treating the substrate, and a developing robot transferring the substrate between the bake chamber of the developing module and the developing chamber.

22. The apparatus of claim 21, wherein the coating module is located at a same height as the pro-treatment module, and the developing module is located at a same height as the post-treatment module.

23. The apparatus of claim 22, further comprising a buffer module disposed between the coating/developing module and the pre/post-exposure treatment module, wherein the buffer module comprises a buffer for temporarily storing the substrate.

24. The apparatus of claim 23, wherein the protective layer coating chamber, a return chamber provided with the pre-treatment robot, and the bake chamber of the pre-treatment module are sequentially arranged in a second direction perpendicular to the first direction when viewed from above;
the cleaning chamber, a return chamber provided with the post-treatment robot, and the post-exposure bake chamber are sequentially arranged in the second direction when viewed from above;
the coating chamber, a return chamber provided with the coating robot, and the bake chamber of the coating module are sequentially arranged in the second direction when viewed from above;
the developing chamber, a return chamber provided with the developing robot, and the bake chamber of the developing module are sequentially arranged in the second direction when viewed from above; and
each of the return chamber provided with the pre-treatment robot, the return chamber provided with the post-treatment robot, the return chamber provided with the coating robot, and the return chamber provided with the developing robot is arranged side by side with the buffer of the buffer module in the first direction.

25. The apparatus of claim 16, further comprising a buffer module disposed between the coating/developing module and the pre/post-exposure treatment module, wherein the buffer module comprises a buffer for temporarily storing the substrate.

26. The apparatus of claim 16, further comprising a first buffer module disposed between the index module and the coating/developing module and a second buffer module disposed between the coating/developing module and the pre/post-exposure treatment module, wherein each of the first and second buffer modules comprises a buffer for temporarily storing the substrate.

27. The apparatus of claim 16, further comprising an interface module connected to an exposure unit.

28-33. (canceled)
